(19) United States
(12) Patent Application Publication
(10) Pub. No.: US 2014/0043466 A1
(43) Pub. Date: Feb. 13, 2014

(54) ENVIRONMENT IMAGE DISPLAY APPARATUS FOR TRANSPORT MACHINE

(71) Applicant: HONDA MOTOR CO., LTD., Tokyo (JP)

(72) Inventors: Masayuki Sato, Wako-shi (JP); Yuya Kishimoto, Wako-shi (JP)

(73) Assignee: HONDA MOTOR CO., LTD., Tokyo (JP)

(21) Appl. No.: 13/958,737

(22) Filed: Aug. 5, 2013

(30) Foreign Application Priority Data
Aug. 7, 2012 (JP) 2012-175221

(51) Int. Cl. B60R 1/00

(52) U.S. Cl. CPC B60R 1/00
USPC 348/115

(57) ABSTRACT

An environment image display apparatus for a transport machine including a plurality of cameras disposed at different positions on said transport machine for obtaining environment images around the transport machine. A mirror image is generated by projecting the transport machine on a virtual mirror using a portion or all of the images obtained by the plurality of cameras, and the generated mirror image is displayed. A display form of the mirror image is changed based on an operation performed by the user of the transport machine or a traveling condition of the transport machine.

### BACKGROUND OF THE INVENTION

1. Field of the Invention

The present invention relates to an environment image display apparatus for a transport machine, such as a vehicle, a ship, and the like, and particularly to an environment image display apparatus for displaying a mirror image which is generated by projecting an environment image around the transport machine and the transport machine itself on a virtual mirror, the environmental image being obtained by cameras.

2. Description of the Related Art

Japanese Patent Laid-open No. 2011-30078 (JP-'078) discloses an image display apparatus for a vehicle, which obtains environment images around the vehicle with a plurality of cameras, generates a bird's-eye view image and/or a mirror image by processing the obtained environment images with a predetermined method, and displays the generated image. According to this apparatus, the viewing angle of the cameras or the displayed image is changed according to a running condition of the vehicle.

According to the apparatus shown in JP-'078, the change in the camera viewing angle and the displayed image is performed considering that the range of the image required by the driver differs depending on the vehicle running condition (upon lane change, backward movement, off-road running, and the like). However, regarding the mirror image, the reduced scale of the displayed image changes due to change in the viewing range, which may cause the driver to erroneously recognize the displayed range or the size of the obstacle, since the mirror image display is performed only by reversely displaying the image obtained by the camera with respect to lateral direction (left-and-right direction) and adding an indication for informing that the displayed image is a mirror image.

### SUMMARY OF THE INVENTION

The present invention is made contemplating the above-described point, and an objective of the present invention is to provide an environment image display apparatus which appropriately displays the mirror image to make the user of the transport machine more accurately recognize the environment state of the transport machine.

To attain the above objective, the present invention provides an environment image display apparatus for a transport machine (1), including a plurality of cameras (11-14) disposed at different positions on the transport machine, mirror image generating means, and display means (17). The plurality of cameras (11-14) obtains environment images around the transport machine. The mirror image generating means generates a mirror image by projecting the transport machine on a virtual mirror using a portion or all of the images obtained by the plurality of cameras (11-14). The display means (17) displays the generated mirror image. The mirror image generating means changes a display form of the mirror image based on an operation performed by the user of the transport machine or a traveling condition of the transport machine.

With this configuration, the mirror image is generated by projecting the transport machine on the virtual mirror using a portion or all of the images obtained by the plurality of cameras, and the generated mirror image is displayed. Further, the display form is changed based on the operation performed by the user of the transport machine or the traveling condition of the transport machine, thereby making it possible to appropriately and effectively inform the user of the environment state of the transport machine.

Preferably, the mirror image generating means includes plane-surface conversion means and curved-surface conversion means. The plane-surface conversion means converts the images obtained by the plurality of cameras (11-14) to a plane-surface image. The curved-surface conversion means converts the images obtained by the plurality of cameras (11-14) to a curved-surface image. The mirror image generating means generates the mirror image based on the operation performed by the user of the transport machine (1) or the traveling condition of the transport machine (1). The mirror image contains at least one of the images converted by the plane-surface conversion means and the curved-surface conversion means.

With this configuration, the images obtained by the plurality of cameras are converted to a plane-surface image and/or a curved-surface image, and the mirror image containing the plane-surface image and/or curved-surface image is generated based on the operation performed by the user of the transport machine or the traveling condition of the transport machine. Accordingly, by displaying the main region to be emphasized with the plane-surface image and displaying the sub-region accompanying the main region with the curved-surface image, for example, the user of the transport machine can appropriately and effectively recognize the environment state of the transport machine.

Preferably, the display form of the mirror image includes a form of the plane-surface image and a form of a column-surface image, and the column-surface image is generated by increasing a number of pixels in the lateral direction of the transport machine (1), compared with the number of pixels of the corresponding plane-surface image.

With this configuration, the display form of the mirror image includes a form of the plane-surface image and a form of the column-surface image and the column-surface image is generated by increasing a number of pixels in the lateral direction of the transport machine, compared with the number of pixels of the corresponding plane-surface image. If it is desired that the environment state near the transport machine is displayed with the plane-surface image which is comparatively easy to see, and the environment state of the region remote from the transport machine should also be displayed, the displayed region can be made wider by displaying the image of the remote region with the column-surface image.

Preferably, the environment image display apparatus further includes bird's-eye view image generating means for generating a bird's-eye view image of the transport machine (1) using the images obtained by the plurality of cameras (11-14) provided with a fish-eye lens. The bird's-eye view image is an image viewing from one of the front side and rear side of the transport machine (1) to the other of the front side and rear side, and the mirror image is an image projected on a virtual mirror disposed on the front side or rear side of the transport machine (1). The display means (17) simultaneously displays both of the bird's-eye view image and the mirror image.

With this configuration, the bird's-eye view image of the transport machine is generated using the images obtained by the plurality of cameras, and the bird's-eye view image is generated as an image viewing from one of the front side and rear side of the transport machine to the other of the front side and rear side. Further, the mirror image is generated as an image projected on the virtual mirror disposed on the front side or rear side of the transport machine, and the both of the bird's-eye view image and the mirror image are simultaneously displayed. Accordingly, by referring to the both images, the user of the transport machine can appropriately and effectively recognize not only the whole environment state around the transport machine but also the detailed environment state near the transport machine.

### BRIEF DESCRIPTION OF THE DRAWINGS

FIG. 1 is a block diagram showing s configuration of an environment image display apparatus for a vehicle according to one embodiment of the present invention;

FIG. 2 illustrates an arrangement of cameras mounted on the vehicle;

FIG. 3 shows an example of a plane-surface mirror image;

FIG. 4 shows an example of a one-axis convex mirror image;

FIG. 5 shows an example of a plane-surface mirror image which is obtained by changing a reflecting direction of the virtual mirror;

FIG. 6 shows an example of a composite-surface mirror image which is obtained by combining the one-axis convex mirror image and the plane-surface mirror image;

FIG. 7 illustrates a method for converting a plane-surface mirror image to the one-axis convex mirror image or the composite-surface mirror image;

FIG. 8 is a flowchart of a process for switching a mirror image to be displayed;

FIG. 9 shows an arrangement of a virtual camera for generating a bird's-eye view image;

FIG. 10 shows an example of a bird's-eye view image; and

FIG. 11 shows an example of a displayed image in which the bird's-eye view image and the mirror image are simultaneously displayed.

### DETAILED DESCRIPTION OF THE PREFERRED EMBODIMENTS

Preferred embodiments of the present invention will now be described with reference to the drawings.

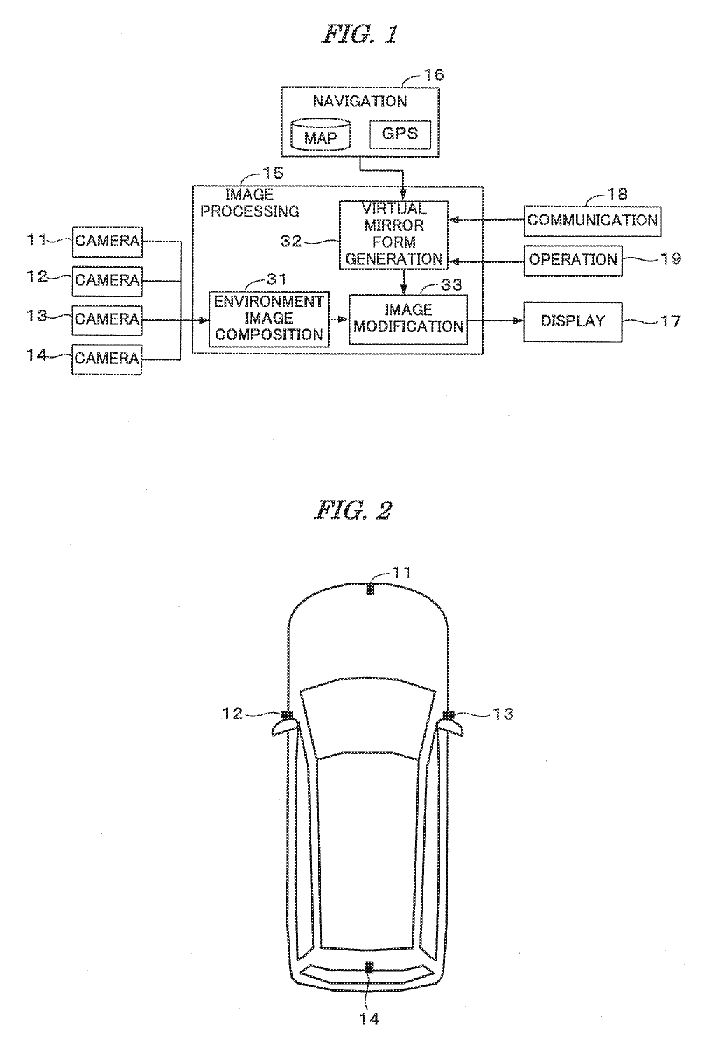

FIG. 1 is a block diagram showing a configuration of an environment image display apparatus for a vehicle according to one embodiment of the present invention. The environment image display apparatus shown in FIG. 1 includes four cameras 11-14 provided with a fish-eye lens, an image processing unit 15, a navigation unit 16, a display block 17, a communication block 18, and an operation block 19. The cameras 11-14 are disposed at different positions on the outer surface portion of the vehicle 1, for obtaining environment images around the vehicle 1. The image processing unit 15 performs a signal processing (image processing) of the image signals obtained by the cameras 11-14. The display block 17 displays the image according to the image signal output from the image processing unit 15. The communication block 18 performs a data transmission among other control units (an engine control unit, a transmission control unit, and the like) mounted on the vehicle 1.

The cameras 11-14 are disposed, as shown in FIG. 2, at the front portion of the vehicle 1, in the vicinity of the left and right fender mirrors, and at the rear portion of the vehicle 1, respectively. The navigation unit 16 is provided with map data and a GPS (Global Positioning System), and supplies an information of the running position of the vehicle 1 and a road information around the vehicle 1, to the image processing unit 15.

The communication block 18 obtains the information (including a vehicle speed, a gear position of the transmission, a winker operating condition, and the like) which shows a running condition of the vehicle 1 from the other control units, and supplies the obtained information to the image processing unit 15. The operation block 19 is configured with a steering switch disposed near the steering wheel, and/or the like, and the operating information by the driver (passenger) of the vehicle 1 is supplied to the image processing unit 15.

The display block 17 is configured, in this embodiment, with the liquid crystal display provided for performing a map screen display and a guidance screen display by the navigation unit 16.

The image processing unit 15 includes an environment image composition block 31, a virtual mirror form generation block 32, and an image modification block 33. The image processing unit 15 generates a vehicle environment image by combining the images obtained by the cameras 11-14, and outputs an image signal corresponding to the generated image. Further, the image processing unit 15 generates, as described below, a mirror image of the vehicle environment image according to the running condition of the vehicle 1 and the driver's operation, and outputs another image signal corresponding to the generated mirror image.

The mirror image is, for example, an image in which the lateral (left-and-right) direction is reversed like the image projected on the room mirror (rear view mirror). In this embodiment, the mirror image is generated by combining the present vehicle image indicative of the vehicle 1 (present vehicle) and the environment image. As the present vehicle image, a photograph image of the present vehicle previously obtained or an illustration image of the present vehicle previously drawn is used.

The environment image composition block 31 generates the vehicle environment image by combining the images obtained by the four cameras 11-14. In this embodiment, as forms of the mirror image, the plane-surface mirror image, the one-axis convex mirror image (column-surface mirror image), and a composite-surface mirror image are used. The composite-surface mirror image is generated by combining the plane-surface image and the one-axis convex mirror image. The virtual mirror form generation block 32 generates a mirror form corresponding to the above-described different form of the mirror according to the information indicative of the running condition of the vehicle 1 and the information indicative of the driver's operation.

The image modification block 33 obtains a required region by cutting a portion of the vehicle environment image and performs an image conversion according to the generated mirror form. Further, the image modification block 33 combines the image of the required region and the present vehicle image to generate a mirror image to be displayed (hereinafter referred to as “display mirror image”), and outputs an image signal corresponding to the generated display mirror image.

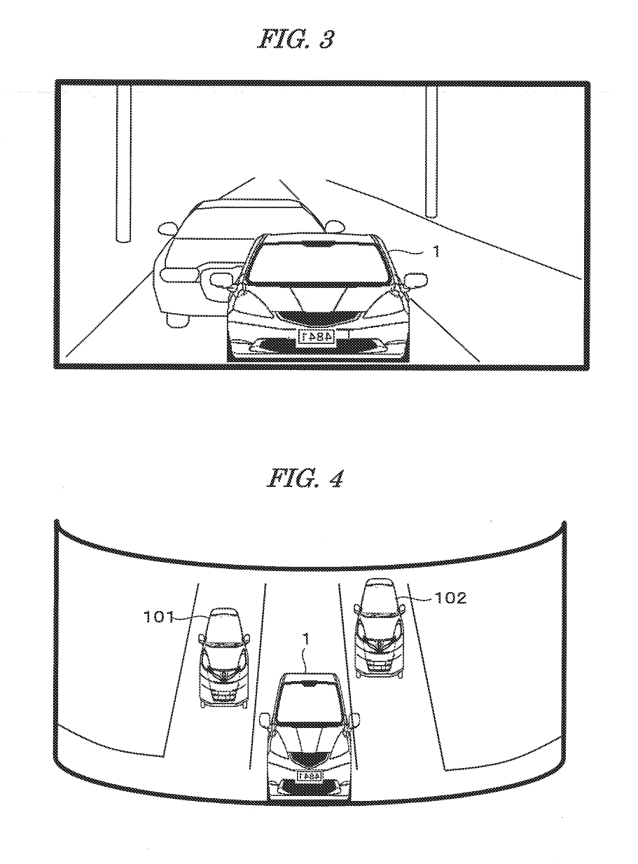

FIG. 3 shows an example of the plane-surface mirror image, in which the present vehicle 1 combined as an illustrated image is shown. When running on a ordinary street road, it is preferable like the ordinary room mirror to set the plane-surface mirror image as the display mirror image, which gives the driver easier sense of distance from the object contained in the mirror image.

On the other hand, when advancing into a crossing or a T-junction of roads of bad prospect, or when moving backward, it is effective to display a wider range including the driver's blind spot. However, it is difficult to display the blind spot information as the plane-surface mirror image, since there is a limit in the screen size of the display block 17 for displaying the mirror image.

Accordingly, in this embodiment, when it is effective to display the blind spot information, the one-axis convex mirror image as shown in FIG. 4 is set as the display mirror image. The one-axis convex mirror image is an image obtained by compressing the plane-surface mirror image in the lateral direction to a lengthwise image. In FIG. 4, other vehicles 101 and 102 are shown with the present vehicle 1, which makes it possible for the driver to surely recognize other vehicles existing in the blind spot. Further, by configuring the frame form of the display mirror image as the curved form as shown in FIG. 4, the driver (passenger) can easily recognize that the one-axis convex mirror image is shown. Consequently, it is possible to prevent the driver from erroneously recognizing the displayed range (having an incorrect sense of distance from the shown object).

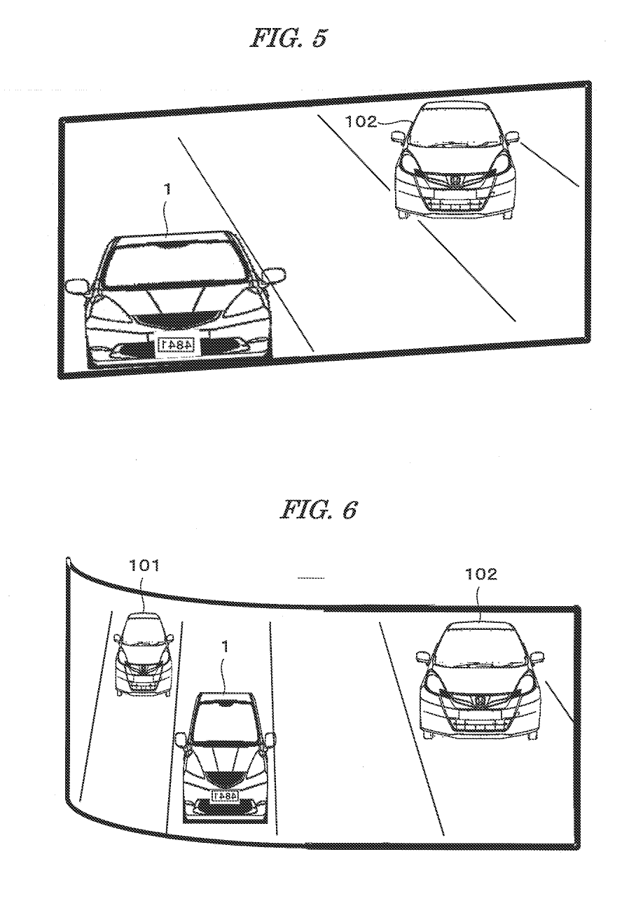

Further, when running on a highway or the like with many lanes, the plane-surface mirror image projected on the virtual mirror disposed in front of the vehicle may normally be shown. However, for example, upon lane change to the right lane (upon generating the winker operation signal to the right lane), it is desirable to display a wider view image corresponding to the region on the right-hand side of the vehicle. In such case, by inclining the virtual mirror applied to generating the plane-surface mirror image toward the right-hand side as shown in FIG. 5 (by performing a right side emphasized display), to widely display the right-hand side region, the driver can easily and directly recognize that the right side emphasized display is performed.

However, when performing the right side emphasized display with the plane-surface mirror image, there is a problem that the blind spot on the left-hand side of the vehicle 1 becomes larger. Therefore, it is desirable to perform the right side emphasized display with a composite-surface mirror image which is obtained by configuring the left half of the display mirror image with the one-axis convex mirror image, and the right half of the display mirror image with the plane-surface mirror image, as shown in FIG. 6. Performing the right side emphasized display with the composite-surface mirror image, makes it possible to display the right side region of the vehicle widely and largely as well as to display the left side region of the vehicle with the laterally-compressed image (lengthwise image), thereby preventing the left side blind spot from becoming larger. It is preferable that the left side emphasized display is performed with the similar method when such display is necessary.

Further, when an obstacle exists on the right rear side of the vehicle, for example, it is possible to inform the driver (passenger) of existence of the obstacle on the right side with emphasis by similarly changing the form of the virtual mirror.

In this embodiment, it is necessary to convert the image display coordinate system for generating the plane-surface mirror image since the camera 11-14 are provided with a fish-eye lens. A known converting method disclosed, for example, in Japanese Patent Laid-open No. H11-18007, can be applied to converting the image display coordinate system.

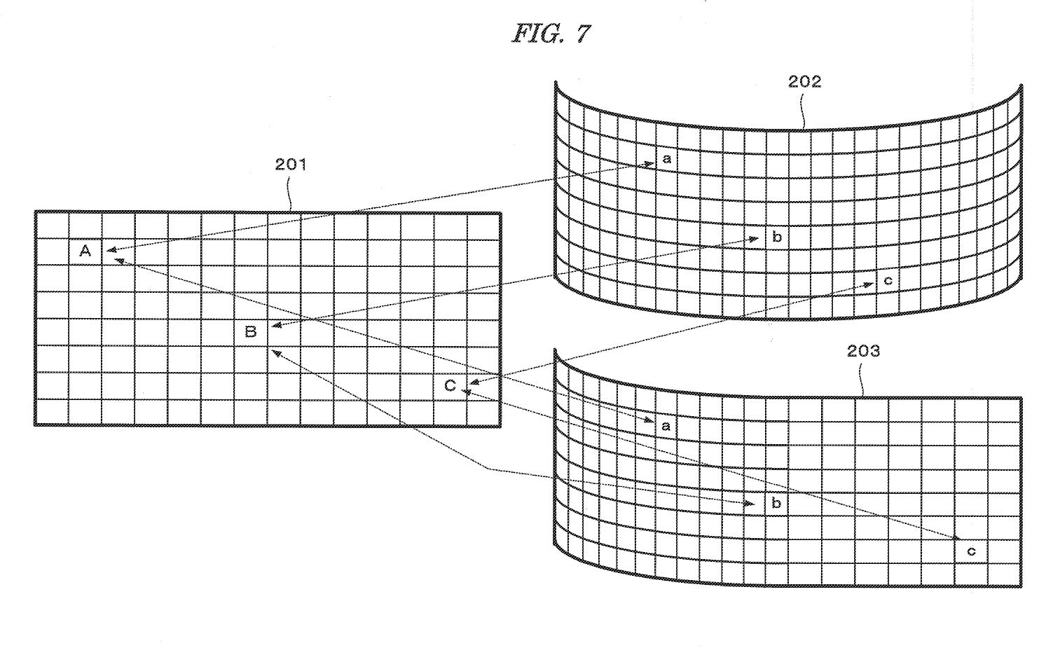

FIG. 7 shows a schematic diagram for explaining a method of conversion from a plane-surface mirror image 201 to a one-axis convex mirror image 202, and a method of conversion from the plane-surface mirror image 201 to a composite-surface mirror image 203. Although the number of pixels of an actual image data is in the range from about several hundreds of thousands to several millions, FIG. 7 is shown in a simplified manner.

Conversion patterns defining the relationships between pixels in one mirror image and pixels in another mirror image are previously set, and the conversion of the image coordinate system is performed according to the previously set conversion patterns. For example, a conversion pattern is set so that the pixels A, B, and C in the plane-surface mirror image 201 correspond respectively to the pixels a, b, and c in the one-axis convex mirror image 202 and the composite-surface mirror image 203.

The one-axis convex mirror image 202 contains a region wider than the plane-surface mirror image 201. Accordingly, it is necessary to obtain an image of the outer region which is not contained in the plane-surface mirror image. It is to be noted that an image signal value corresponding to one pixel in the curved-surface mirror image may be determined with a method such as the linear interpolation upon actual conversion, since pixels of the two images (the original image and the converted image) do not actually correspond one-to-one.

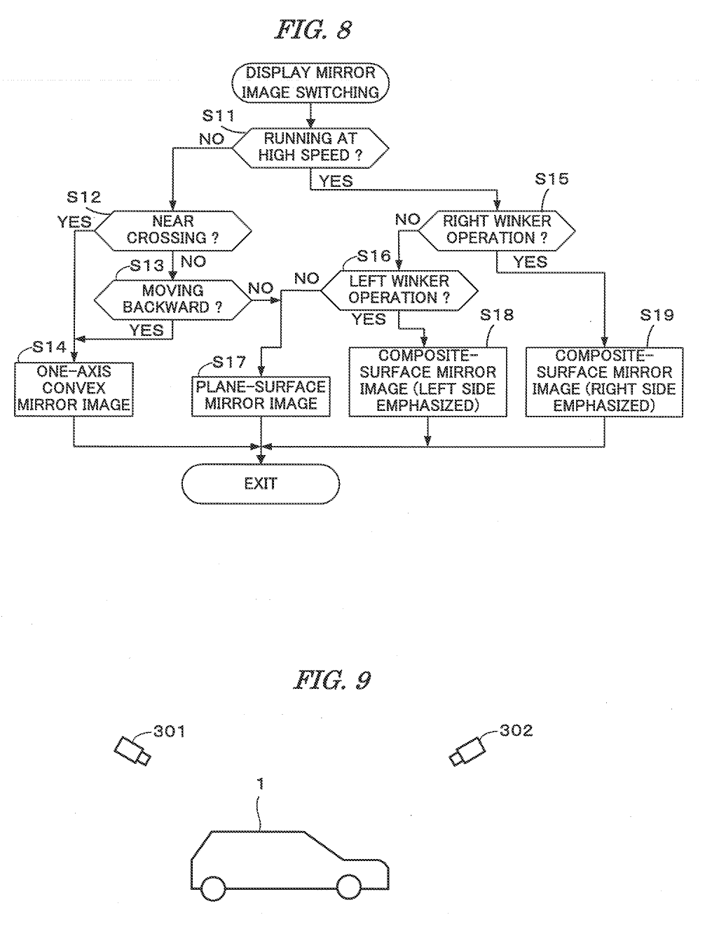

FIG. 8 is a flowchart of a process for performing switching of the display mirror image according to a running condition (traveling condition) of the present vehicle 1. This process is executed at predetermined intervals in the virtual mirror form generation block 32 shown in FIG. 1.

In step S11, it is determined whether or not the vehicle 1 is running at a comparatively high speed (e.g., 80 [km/h ] or more). If the answer to step S11 is negative (NO), it is further determined whether or not the vehicle 1 is in the vicinity of a crossing of roads (step S12). If the answer to step S12 is affirmative (YES), the one-axis convex mirror image is selected (step S14).

If the answer to step S12 is negative (NO), it is further determined whether or not the vehicle 1 is moving backward (step S13). If the answer to step S13 is affirmative (YES), the process proceeds to step S14, to select the one-axis convex mirror image. If the vehicle is not moving backward, the plane-surface mirror image is selected (step S17).

If the vehicle 1 is running at a comparatively high speed, the process proceeds from step S11 to step S15, and it is further determined whether or not the right winker signal is being output. If the answer to step S15 is affirmative (YES), the composite-surface mirror image (the right side emphasized display) is selected (step S19). If the answer to step S15 is negative (NO), it is further determined whether or not the left winker signal is being output (step S16). If the answer to step S16 is affirmative (YES), the composite-surface mirror image (the left side emphasized display) is selected (step S18). If the answer to step S16 is negative (NO), i.e., if continuing the high-speed straight running, the plane-surface mirror image is selected (step S17).

It is to be noted that, in step S11, whether the vehicle 1 is running on a highway may be determined based on the information from the navigation unit 16.

With the process of FIG. 8, a suitable display mirror image can be selected according to the running condition of the present vehicle 1. It is to be noted that the image processing unit 15 is configured so that the display mirror image can be switched not only with the process shown in FIG. 8 but also with the switching operation performed by the driver or passenger through the operation block 19.

The image processing unit 15 in this embodiment is configured so that two types of the bird's-eye view images can be composed. As shown in FIG. 9, one is a bird's-eye view image with a first virtual camera 301 provided for imaging at a view point from the rear side to the front side of the vehicle 1, and the other is a bird's-eye view image with a second virtual camera 302 provided for imaging at a view point from the front side to the rear side of the vehicle 1. Further, the image processing unit 15 displays the composed bird's-eye view image and the above-described mirror image in parallel (simultaneously) on the screen of the display block 17. The method disclosed in JP-'078 described above is applicable to composing the bird's-eye view image.

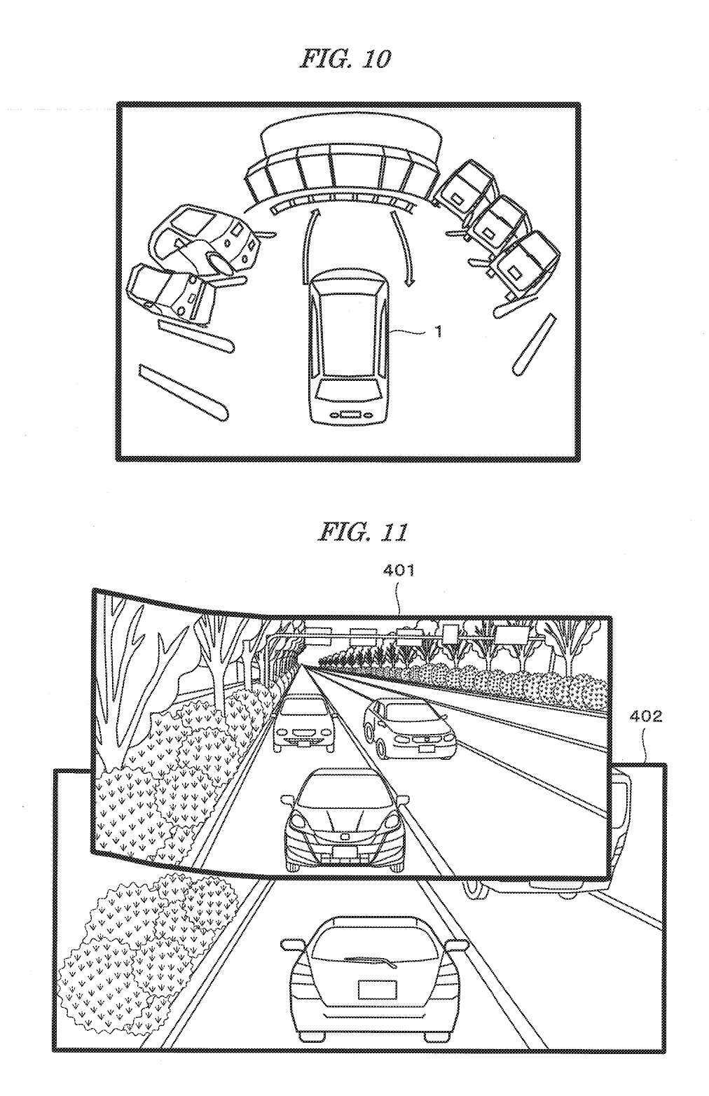

FIG. 10 shows an example of a bird's-eye view image (including an image of the present vehicle 1) obtained with the first virtual camera 301. By simultaneously displaying such a bird's-eye view image and the one-axis convex mirror image or the composite-surface mirror image, it is possible for the driver or passenger of the vehicle 1 to appropriately and effectively recognize the overall situation around the vehicle 1 and the detailed situation near the vehicle 1.

As described above, in this embodiment, the mirror image is generated by projecting the present vehicle 1 on the virtual mirror using the images obtained by the plurality of cameras 11-14, and the generated mirror image is displayed on the display block 17. Further, the display form is changed based on the operation performed by the passenger of the vehicle or the running condition of the vehicle 1, thereby making it possible to appropriately and effectively inform the user of the environment state around the vehicle 1.

Specifically, the images obtained by the plurality of cameras 11-14 are converted to the plane-surface image and the one-axis convex surface mirror image, and the plane-surface image, the one-axis convex surface image, or the composite-surface mirror image is generated based on the operation performed by the user of the vehicle 1 or the running condition of the vehicle 1. Accordingly, by displaying the main region to be emphasized with the plane-surface image and displaying the sub-region accompanying the main region with the one-axis convex mirror image, for example, it is possible for the user of the vehicle 1 to appropriately and effectively recognize the environment state of the vehicle 1.

The one-axis convex mirror image is generated by increasing a number of pixels in the lateral direction of the vehicle 1, compared with the number of pixels of the corresponding plane-surface image. If it is desired that the environment state near the vehicle 1 is displayed with the plane-surface image which is comparatively easy to see, and the environment state of the region remote from the vehicle 1 should also be displayed, the displayed region can be made wider by displaying the image of the remote region with the one-axis convex mirror image, so that the passenger of the vehicle 1 can recognize the state with respect to a wider region.

The bird's-eye view image around the vehicle 1 is generated using the images obtained by the plurality of cameras 11-14, and the bird's-eye view image is generated as an image viewing from the front side to the rear side or from the rear side to the front side of the vehicle 1. Further, the mirror image is generated as an image projected on the virtual mirror disposed on the front side of the vehicle 1, and both of the mirror image 401 and the bird's-eye view image 402 are simultaneously displayed by the display block 17 as shown in FIG. 11, for example. Accordingly, by referring to the both images, the passenger of the vehicle 1 can appropriately and effectively recognize not only the whole environment state of the vehicle 1 but also the detailed environment state near the vehicle 1.

In this embodiment, the display block 17 corresponds to the display means, and the image processing unit 15 constitutes the mirror image generating means, the plane-surface conversion means, the curved-surface conversion means, and the bird's-eye view image generating means.

The present invention is not limited to the embodiment described above, and various modifications may be made. For example, the curved-surface mirror is not limited to the one-axis convex surface mirror, and a two-axes convex surface mirror, a free-form surface mirror, and the like may be used as the curved-surface mirror. Further, in the above-described embodiment, the mirror image is projected on the virtual mirror disposed on the front side of the vehicle. Alternatively, the mirror image may be projected on the virtual mirror disposed on the rear side of the vehicle.

Further, the cameras 11-14 are not limited to those having a fish-eye lens, but the cameras 11-14 may be provided with a convex lens for normal cameras. The display block 17 may be configured with a head-up display, and the display screen may be projected on the front window of the vehicle in front of the vehicle driver. In this case, the mirror image is also projected on the front window. Further, in the above-described embodiment, an example in which the transport machine is a vehicle is shown, but the present invention may be applicable to a transport machine such as a ship or an airplane, for example.

What is claimed is:

1. An environment image display apparatus for a transport machine, comprising:
a plurality of cameras disposed at different positions on said transport machine for obtaining environment images around said transport machine;
mirror image generating means for generating a mirror image by projecting said transport machine on a virtual mirror using a portion or all of the images obtained by said plurality of cameras; and
display means for displaying the generated mirror image,
wherein said mirror image generating means changes a display form of the mirror image based on an operation performed by the user of said transport machine or a traveling condition of said transport machine.

2. The environment image display apparatus according to claim 1, wherein said mirror image generating means includes:
plane-surface conversion means for converting the images obtained by said plurality of cameras to a plane-surface image; and
curved-surface conversion means for converting the images obtained by said plurality of cameras to a curved-surface image,
wherein said mirror image generating means generates the mirror image based on the operation performed by the user of said transport machine or the traveling condition of said transport machine, said mirror image containing at least one of the images converted by said plane-surface conversion means and said curved-surface conversion means.

3. The environment image display apparatus according to claim 2, wherein the display form of the mirror image includes a form of the plane-surface image and a form of a column-surface image,
wherein the column-surface image is generated by increasing a number of pixels in the lateral direction of said transport machine, compared with the number of pixels of the corresponding plane-surface image.

4. The environment image display apparatus according to claim 1, further comprising bird's-eye view image generating means for generating a bird's-eye view image of said transport machine using the images obtained by said plurality of cameras, said plurality of cameras being provided with a fish-eye lens,
wherein the bird's-eye view image is an image viewing from one of the front side and rear side of said transport machine to the other of the front side and rear side, and the mirror image is an image projected on a virtual mirror disposed on the front side or rear side of said transport machine,
wherein said display means simultaneously displays both of the bird's-eye view image and the mirror image.

5. An environment image display method for a transport machine provided with a plurality of cameras disposed at different positions on said transport machine for obtaining environment images around said transport machine, said method comprising the steps of:
a) generating a mirror image by projecting said transport machine on a virtual mirror using a portion or all of the images obtained by said plurality of cameras; and
b) displaying the generated mirror image,
wherein a display form of the mirror image is changed based on an operation performed by the user of said transport machine or a traveling condition of said transport machine.
